(19) United States
(12) Patent Application Publication
(10) Pub. No.: US 2010/0138859 A1
(43) Pub. Date: Jun. 3, 2010

(54) IMAGE PROCESSING APPARATUS, SERVER AND CONTROL METHOD OF THE SAME

(75) Inventor: Seong-il KO, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/475,828

(22) Filed: Jun. 1, 2009

(30) Foreign Application Priority Data
Dec. 1, 2008 (KR) 10-2008-0120612

(51) Int. Cl. H04N 5/445; H04N 7/173

(52) U.S. Cl. 725/37; 725/131; 725/134; 725/116

(57) ABSTRACT

Disclosed are an image processing apparatus which easily plays contents, a server and a control method of the same. The image processing apparatus includes: a communication unit which communicates with a server; a signal processor; and a controller which determines whether a received content is processed by the signal processor and controls the communication unit to transmit the received content to the server and receive a converted content from the server if it is determined that the received content is not processed by the signal processor.

### CROSS-REFERENCE TO RELATED APPLICATION

This application claims priority from Korean Patent Application No. 2008-0120612, filed on Dec. 1, 2008, in the Korean Intellectual Property Office, the disclosure of which is incorporated herein by reference.

### BACKGROUND OF THE INVENTION

1. Field of the Invention

Apparatuses and methods consistent with the present invention relate to an image processing apparatus, a server and a control method of the same, and more particularly, to an image processing apparatus which processes and plays contents, a server which communicates with the image processing apparatus and a control method of the same.

2. Description of the Related Art

Recently, with widespread use of digital TV, a user may view contents from a TV, such as video contents that are input to a TV through a storage medium based on a universal serial bus (USB) or a network, and then played by a codec included in the TV.

Since the contents are decoded by the codec which was used for encoding the contents, contents which are playable from a TV are restricted by a codec included in the TV.

As contents compression techniques have become varied, a low compatibility of a codec makes contents hard to be played from a TV.

### SUMMARY OF THE INVENTION

According to an aspect of the present invention, there is provided an image processing apparatus which easily plays contents, a server and a control method of the same.

According to another aspect of the present invention, there is provided an image processing apparatus, a server and a control method of the same, which can play contents different in a format excluding possibility of error.

The foregoing and/or other aspects of the present invention can be achieved by providing a image processing apparatus that may include: a communication unit which communicates with a server; a signal processor; and a controller which determines whether a received content is processed by the signal processor and controls the communication unit to transmit the received content to the server and receive a converted content from the server if it is determined that the received content is not processed by the signal processor.

The controller may transmit performance information about the signal processor to the server.

The controller may transmit format information about a content format that is processed by the signal processor, to the server.

The controller may transmit a request signal for converting a format of the received content to the server, and transmit the received content to the server if a response to the request signal is received from the server.

The image processing apparatus may further include an external connection unit which connects to an external device that stores content.

The image processing apparatus may further include a storage unit which stores the converted content, wherein the controller stores in the storage unit the converted content which is transmitted from the server.

The image processing apparatus may further include a user interface (UI) generator which generates UI information, wherein the controller controls the UI generator to generate content playing information to inform a user of whether the received content is processed or converted.

The signal processor may include a codec.

The image processing apparatus may further include a broadcasting receiver which receives a broadcasting signal.

The foregoing and/or other aspects of the present invention can be achieved by providing a server that may include: a communication unit which communicates with an image processing apparatus; and a controller which converts a format of a received content into a format to be processed by a signal processor of the image processing apparatus and controls the communication unit to transmit the converted content having the converted format to the image processing apparatus if the received content is received from the image processing apparatus.

The controller may convert the format of the content based on at least one of performance information about the image processing apparatus and format information about a content format which is processed by the signal processor of the image processing apparatus is received from the image processing apparatus.

The controller may convert the format of the received content into an internet protocol TV (IPTV) format to be played by an IPTV and transmits the converted content to the image processing apparatus.

The controller may transmit a response signal corresponding to a request signal to the image processing apparatus if the request signal for converting the format of the received content is received from the image processing apparatus.

The foregoing and/or other aspects of the present invention can be achieved by providing a control method of an image processing apparatus which communicates with a server, the control method may include: determining whether a received content is processed; transmitting the content to the server if it is determined that the content is not processed; and receiving a converted content having format of the received content, from the server.

The control method may further include a signal processor which processes a content, and the transmitting the received content to the server may include transmitting performance information about the signal processor of the image processing apparatus, to the server.

The transmitting the received content to the server may include transmitting format information about a content format that is processed to the server.

The foregoing and/or other aspects of the present invention can be achieved by providing a control method of a server, the control method may include: receiving a content from a image processing apparatus; converting a format of the received content into a format to be processed by a signal processor of the image processing apparatus; and transmitting the converted content having the converted format to the image processing apparatus.

The converting the received content may include converting the received content into a format of an internet protocol TV (IPTV).

The control method may further include transmitting a response signal corresponding to a request signal to the image processing apparatus if the request signal is received from the image processing apparatus to request the content conversion.

The foregoing and/or other aspects of the present invention can be achieved by providing an image processing apparatus that may include: an input unit which receives content; a control unit which determines whether a format of the received content is compatible with a signal processor; and a communication unit which transmits the received content to a server to be converted into the format compatible with the signal processor, if it is determined that the format of the received content is not compatible with the signal processor.

The communication unit may receive converted content corresponding to the received content transmitted to the server by the communication unit.

The image processing apparatus may further include a storage unit which stores the converted content.

The foregoing and/or other aspects of the present invention can be achieved by providing an image processing system that may include an image processing apparatus; and a server.

The image processing apparatus may include an input unit which receives content; a first control unit which determines whether a format of the received content is compatible with a signal processor; and a first communication unit which transmits the received content to the server, if it is determined that the format of the received content is not compatible with the signal processor.

The server may include a second communication unit which receives the received content that is transmitted by the communication unit; and a second controller which converts a format of a received content into the format compatible with the signal processor and controls the communication unit to transmit the converted content to the first communication unit of image processing apparatus.

### BRIEF DESCRIPTION OF THE DRAWINGS

The above and/or other aspects of the present invention will become apparent and more readily appreciated from the following description of the exemplary embodiments, taken in conjunction with the accompanying drawings of which:

FIG. 1 is a schematic view of an image processing system according to an exemplary embodiment of the present invention;

FIG. 2 is a control block diagram of an image processing apparatus in FIG. 1;

FIG. 3 is a control block diagram of a server in FIG. 1;

FIGS. 4A and 4B illustrate user interface (UI) information of the image processing apparatus in FIG. 1; and

FIG. 5 is a control flowchart which describes a control method of the image processing apparatus and the server in FIG. 1.

### DETAILED DESCRIPTION OF EXEMPLARY EMBODIMENTS

Hereinafter, exemplary embodiments of the present invention will be described with reference to accompanying drawings, wherein like numerals refer to like elements and repetitive descriptions will be avoided as necessary.

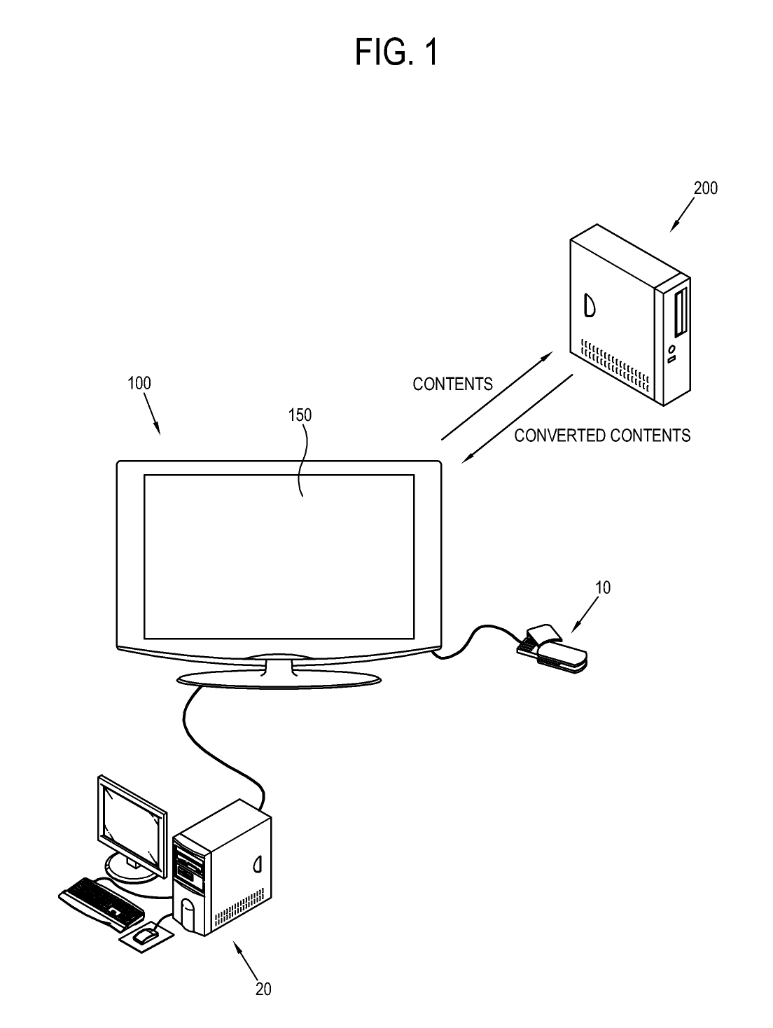

FIG. 1 is a schematic view of an image processing system according to an exemplary embodiment of the present invention. As shown therein, the image processing system includes an image processing apparatus 100 and a server 200. The image processing apparatus 100 and the server 200 are connected to each other through a predetermined communication unit. The image processing apparatus 100 receives and transmits various control signals and data, from and to the communication unit through the communication unit. The image processing apparatus 100 according to the present exemplary embodiment transmits contents to the server 200, and the server 200 converts the transmitted contents and transmits the converted contents back to the image processing apparatus 100.

The image processing apparatus 100 may include a TV which processes contents to be displayed on a display unit 150. If the image processing apparatus 100 includes a TV, it may further comprise an internet protocol TV (IPTV) which is connected to the server 200 by an internet protocol. The contents include audio contents, video contents, digital contents and multimedia contents. The processing of the contents includes playing of the contents. As shown therein, the contents may be supplied to the image processing apparatus 100 from an external storage unit 10 such as a universal serial bus (USB) memory device or stored in advance in an internal memory (not shown) of the image processing apparatus 100. Further, the contents may be input through another electronic device 20 which is connected through the server 200 or a network interface.

The image processing apparatus 100 may further include a set-top box which does not include the display unit 150. The image processing apparatus 100 may further include various terminals, for example, telephones, computers, personal digital assistants (PDAs), portable multimedia players and so on to communicate with the server 200 while playing contents.

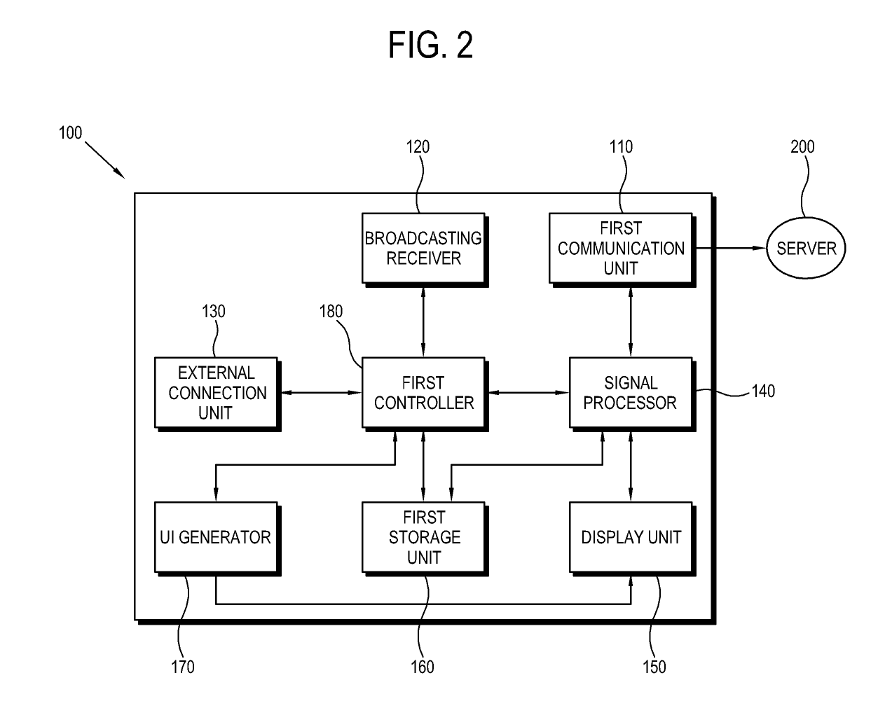

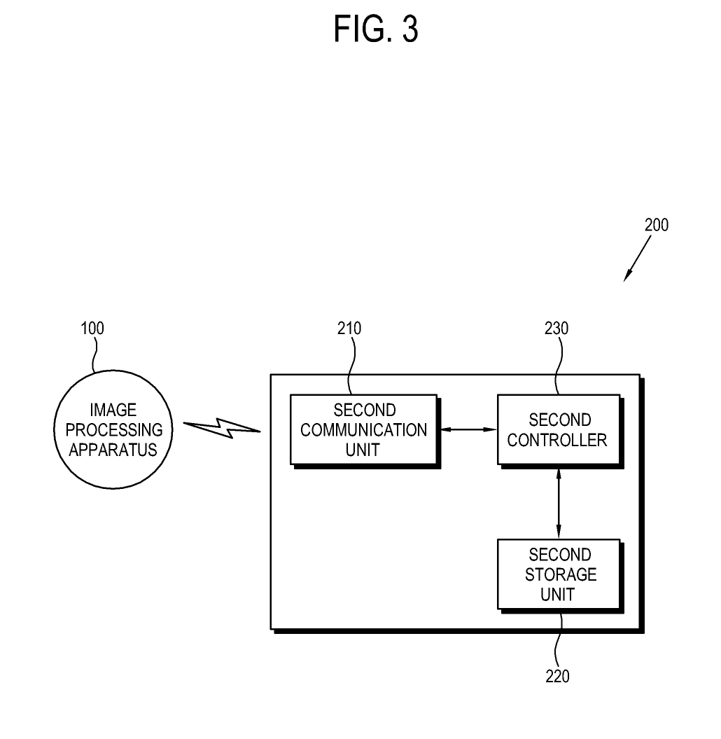

The server 200 provides the image processing apparatus 100 with various services, corresponding to a request signal received from the image processing apparatus 100. The server 200 may include a storage unit which stores therein data needed for providing services, and a controller which processes data and controls a communication with the image processing apparatus 100. Referring to FIG. 2, a control block diagram of the image processing apparatus 100 and FIG. 3, a control block diagram of the server 200, the image processing apparatus 100 and the server 200 will be described in detail hereinbelow.

As shown in FIG. 2, the image processing apparatus 100 includes a first communication unit 110, a broadcasting receiver 120 which receives a broadcasting signal, an external connection unit 130, a signal processor 140, the display unit 150, a first storage unit 160, a user interface (UI) generator 170 and a first controller 180 which controls the foregoing elements. As in FIG. 3, the server 200 includes a second communication unit 210, a second storage unit 220 and a second controller 230.

The first communication unit 110 communicates with the second communication unit 210 of the server 200, transmits a request signal for contents and conversion of contents to the server 200 and receives a response signal and converted contents from the server 200.

The broadcasting receiver 120 includes an antenna and tuner which receive and process a broadcasting signal.

The external connection unit 130 includes an interface to which an external device having contents stored therein is connected. As in FIG. 1, the external connection unit 130 includes a universal serial bus (USB) interface or a network interface. As it is possible now for a user to play contents as well as view a broadcasting signal from a TV, interfaces, to which contents are inputtable, are becoming varied.

The signal processor 140 processes and plays contents, and includes at least one codec to play contents. The codec is software which serves as a coder to convert an audio or video signal into a digital signal and a decoder to convert the digital signal back into the audio or video signal, contrary to the coder. Various types of codecs such as MPEG developed by Microsoft, MOV by Apple, DviX, etc. are available. However, these codecs are not compatible with each other and thus a content which is played by a specific codec may not be played by another codec. That is, a format of a content which is processed by a specific codec is determined. Thus, if a content whose format is not processed by a codec is input to the signal processor 140, it may not be played. The format of contents vary by a method of coding, i.e., a compression method.

Comparing a TV which receives a broadcasting signal with a computer, software or a processing block which processes a signal may not be easily upgraded or downloaded. Even if the software or the processing block is downloaded without difficulty, malfunction may occur or it is difficult to maintain the software due to the downloading. In consideration of the above matters, it is not easy to upgrade or download the codec practically. If a specific codec is not processed by the signal processor 140, a user may not play a content even if it is present.

If the playing of contents is selected by a user, the first controller 180 determines whether the contents are processed by the signal processor 140. If it is determined that the contents are not processed by the signal processor 140, i.e., if it is determined that the contents are not played, the first controller 180 controls the first communication unit 110 to transmit the contents to the server 200. Here, the first controller 180 may transmit information about performance of the signal processor 140 in respect of signal processing, i.e., information about the codec itself, or transmit format information about contents to be processed by the signal processor 140 to the server 200.

The second communication unit 210 of the server 200 receives at least one of performance information and format information about contents; and contents from the image processing apparatus 100.

The second storage unit 220 which belongs to the server 200 stores therein database to convert a format of the contents, and may store therein a plurality of codecs or a unified codec. The second storage unit 220 may belong to the second controller 230 or be provided as an additional memory block.

The second controller 230 converts a format of contents based on transmitted information into a format to be processed by the image processing apparatus 100, and transmits the converted contents back to the image processing apparatus 100. That is, the second controller 230 compresses the contents according to the codec which belongs to the signal processor 140 to thereby decode the contents by the signal processor 140. The second controller 230 may convert the format of the contents after having fully received the contents from the image processing apparatus 100 or convert the format of the contents in line with the reception of the contents for a faster service.

If the image processing apparatus 100 includes an IPTV according to the exemplary embodiment of the present invention, the second controller 230 may convert the format of the contents into a specific format to be played by the IPTV. That is, if a standard for an image signal to be played by the IPTV is set, the second controller 230 may convert the contents corresponding to the standard.

As described above, the image processing apparatus 100 according to the present exemplary embodiment performs a content conversion through the server 200 and receives the converted contents to be provided to a user if an unplayable content is acknowledged. Thus, even if a content having a new format, other than an existing format, is input, a user does not need to download additional software. Therefore, bugs, errors, malfunctions and so on due to the software may be prevented. As only the server 200 processes the contents with a new format, it is easier to manage the image processing system than to individually manage the image processing apparatus 100.

Meanwhile, if a control signal for a content playing is input, the UI generator 170 generates UI information about the content that is playing so that a user may recognize whether the contents are processed or converted.

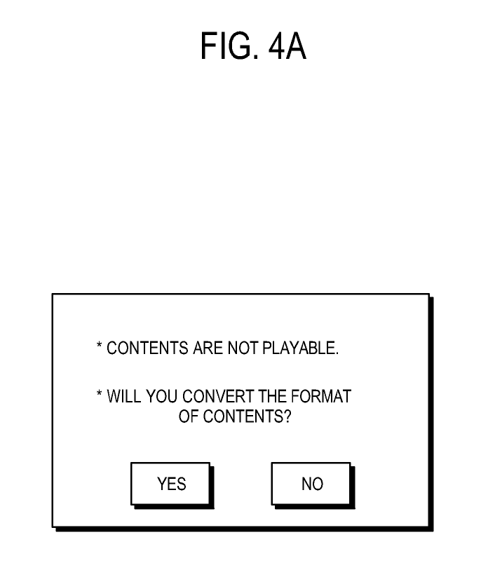

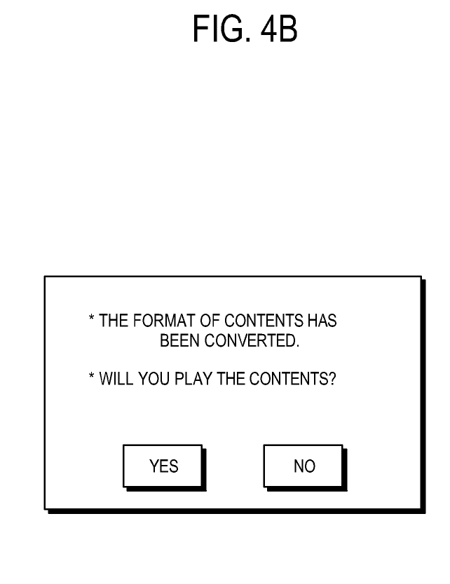

FIGS. 4A and 4B illustrate UI information which is generated by the UI generator 170. If a specific content is selected by a user to be played but it is not processed by the signal processor 140, the UI generator 170 may generate UI information according to a control of the first controller 180 as in FIG. 4A. A user may then recognize that the contents are not playable and may select a format conversion to play the content. The image processing apparatus 100 may further include an input unit such as a remote controller or a touch panel as an interface for a user's selection.

If the contents are not played, a content conversion through the server 200 without a user's selection may be set as a default. In this case, the UI generator 170 may generate UI information informing the contents conversion “The content conversion has been requested. Please wait” unlike FIG. 4A.

FIG. 4B illustrates UI information which asks a user whether to play the contents if the contents whose format was converted is received from the server 200. If a user selects to play the contents, the first controller 180 controls the signal processor 140 and the display unit 150 to play the contents. The first controller 180 may store the converted contents in the first storage unit 160 to be viewed by a user again or store them in an external storage unit such as a USB memory device. In any case, whether to store the contents is determined by a user's selection.

If a user does not select the content playing, the first controller 180 may store the contents having the converted format in the first storage unit 160.

Even though it is not shown in drawings, the UI generator 170 may provide a user with a list about contents currently input to the image processing apparatus 100 or stored therein.

According to another exemplary embodiment, the first controller 180 may transmit a request signal for converting a format of contents to the server 200 before transmitting the contents to the server 200. In this case, the server 200 transmits a confirmation signal about whether to convert the format of the contents or a response signal approving the request corresponding to the request signal, to the image processing apparatus 100. The first controller 180 transmits the contents and the concerned information to the server 200 after receiving the response signal.

According to another exemplary embodiment, the first controller 180 may transmit only a request signal and format information about the contents if the contents are not played through the signal processor 140. The server 200 may transmit contents having a format desired by the image processing apparatus 100 to the image processing apparatus 100, corresponding to the request signal. In this case, the server 200 should store therein various contents compressed in various formats.

The foregoing exemplary embodiments focus on video contents, but they may also be applicable to play an audio signal such as music.

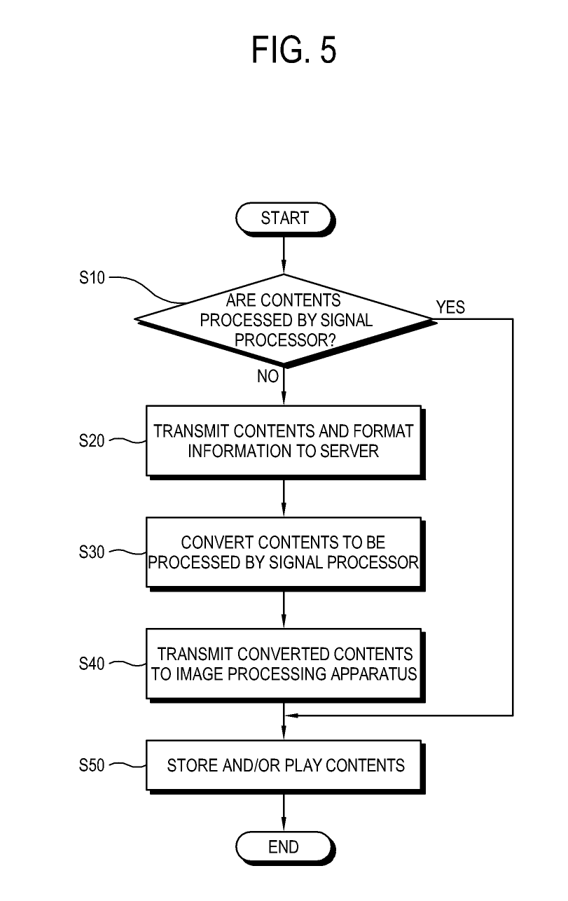

FIG. 5 is a control flowchart which describes a control method of the image processing apparatus 100 and the server 200 in FIG. 1. Referring to FIG. 5, the control method according to the present exemplary embodiment will be described hereinbelow.

If contents are input or a user selects to play a specific content, the first controller 180 determines whether the contents are processed by the signal processor 140 (S10).

If it is determined that the contents are not playable by the signal processor 140, the first controller 180 transmits the contents and information for converting the format of the contents to the server 200 (S20).

The first controller 180 may transmit a request signal for converting the contents and receive a response signal corresponding to the request signal before transmitting the contents.

The server 200 converts the format of the transmitted contents into a format to be processed by the image processing apparatus 100 (S30), and then transmits the converted contents back to the image processing apparatus 100 (S40).

The first controller 180 may play or store the transmitted contents according to a user's selection (S50).

Aspects of the present invention provide apparatus and methods to convert a format of contents by using a server communicating with an image processing apparatus to thereby easily play the contents which were not playable in the image processing apparatus whose codec is not easily upgraded or downloaded.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. An image processing apparatus comprising:
a communication unit which communicates with a server;
a signal processor; and
a controller which determines whether a content is processed by the signal processor and controls the communication unit to transmit the content to the server and receive a converted content from the server if it is determined that the content is not processed by the signal processor.

2. The image processing apparatus according to claim 1, wherein the controller transmits performance information about the signal processor to the server.

3. The image processing apparatus according to claim 1, wherein the controller transmits format information about a content format that is processed by the signal processor, to the server.

4. The image processing apparatus according to claim 1, wherein the controller transmits a request signal for converting a format of the content to the server, and transmits the content to the server if a response to the request signal is received from the server.

5. The image processing apparatus according to claim 1, further comprising an external connection unit which connects to an external device that stores the content.

6. The image processing apparatus according to claim 1, further comprising a storage unit which stores the converted content, wherein
the controller stores in the storage unit the received converted content which is transmitted from the server.

7. The image processing apparatus according to claim 1, further comprising a user interface (UI) generator which generates UI information, wherein
the controller controls the UI generator to generate content playing information to inform a user of whether the content is processed or converted.

8. The image processing apparatus according to claim 1, wherein the signal processor comprises a codec.

9. The image processing apparatus according to claim 1, further comprising a broadcasting receiver which receives a broadcasting signal.

10. A server comprising:
a communication unit which communicates with an image processing apparatus; and
a controller which converts a format of a received content into a format to be processed by a signal processor of the image processing apparatus and controls the communication unit to transmit the converted content having the converted format to the image processing apparatus if the content is received from the image processing apparatus.

11. The server according to claim 10, wherein the controller converts the format of the content based on at least one of performance information about the signal processor of the image processing apparatus and format information about a content format which is processed by the signal processor of the image processing apparatus, received from the image processing apparatus.

12. The server according to claim 10, wherein the controller converts the format of the received content into an internet protocol TV (IPTV) format to be played by the IPTV and transmits the converted content to the image processing apparatus.

13. The server according to claim 10, wherein the controller transmits a response signal corresponding to a request signal to the image processing apparatus if the request signal for converting the format of the content is received from the image processing apparatus.

14. A control method of an image processing apparatus which communicates with a server, the control method comprising:
determining whether a content is processed;
transmitting the content to the server if it is determined that the content is not processed; and
receiving a converted content having format of the content converted, from the server.

15. The control method according to claim 14, wherein the image processing apparatus further comprises a signal processor which processes a content, and
the transmitting the content to the server comprises transmitting performance information about the signal processor of the image processing apparatus, to the server.

16. The control method according to claim 14, wherein the transmitting the content to the server comprises transmitting format information about a content format that is processed to the server.

17. A control method of a server, the control method comprising:
receiving a content from a image processing apparatus;
converting a format of the received content into a format to be processed by a signal processor of the image processing apparatus; and
transmitting the converted content having the converted format to the image processing apparatus.

18. The control method according to claim 17, wherein the converting the received content comprises converting the received content into a format of an internet protocol TV (IPTV).

19. The control method according to claim 17, further comprising transmitting a response signal corresponding to a request signal to the image processing apparatus if the request signal is received from the image processing apparatus to request the content conversion.

20. An image processing apparatus comprising:
an input unit which receives content;
a control unit which determines whether a format of the received content is compatible with a signal processor;
a communication unit which transmits the received content to a server to be converted into the format compatible with the signal processor, if it is determined that the format of the received content is not compatible with the signal processor.
